(19) United States
(12) Patent Application Publication
(10) Pub. No.: US 2023/0276369 A1
(43) Pub. Date: Aug. 31, 2023

(54) METHOD AND APPARATUS FOR PERFORMING UPLINK POWER CONTROL AND UPLINK CHANNEL TRANSMISSION

(71) Applicant: Samsung Electronics Co., Ltd., Suwon-si, Gyeonggi-do (KR)

(72) Inventors: Jingxing FU, Beijing (CN); Feifei SUN, Beijing (CN); Yi WANG, Beijing (CN)

(21) Appl. No.: 18/001,224

(22) PCT Filed: Jun. 17, 2021
(86) PCT No.: PCT/KR2021/007638

§ 371 Date: Dec. 8, 2022

(30) Foreign Application Priority Data
Jun. 19, 2020 (CN) 202010568091.4

(51) Int. Cl. H04W 52/14; H04L 5/00

(52) U.S. Cl. CPC H04W 52/146; H04L 5/0051

(57) ABSTRACT

Embodiments of the present disclosure relate to uplink power control and uplink channel transmission, and provide a method for determining uplink channel power control groups, a method for uplink power control, a method for transmitting uplink channel transmissions, and a user equipment. The method for performing of the uplink power control comprises: receiving at least one control information; grouping at least one uplink channel transmission into at least one uplink channel power control group based on at least one information regarding power control included in the received control information, wherein transmission power of uplink channel transmissions included in one of the at least one uplink channel power control group are set to be same; and adjusting power of the at least one uplink channel power control group based on accumulated values of closed-loop power control corresponding each uplink channel power control group.

### CROSS-REFERENCE TO RELATED APPLICATIONS

This application is a 371 National Stage of International Application No. PCT/KR2021/007638, filed Jun. 17, 2021, which claims priority to Chinese Patent Application No. 202010568091.4, filed Jun. 19, 2020, the disclosures of which are herein incorporated by reference in their entirety.

### BACKGROUND

### 1. Field

The present disclosure relates to a technical field of wireless communication. Specifically, to uplink power control and uplink channel transmission, the present disclosure includes a method for performing uplink power control, a method for transmitting uplink channel transmissions, an apparatus for performing uplink power control and an apparatus for transmitting uplink channel transmission.

### 2. Description of Related Art

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100µsec, and thus will be 50 times as fast as 5G communication systems and have the ⅒ radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### SUMMARY

For efficient uplink power control and uplink channel transmission, a method for performing uplink power control, a method for transmitting uplink channel transmissions, an apparatus for performing uplink power control and an apparatus for transmitting uplink channel transmission is required.

Embodiments of the present disclosure relate to uplink power control and uplink channel transmission, and provide a method for determining uplink channel power control groups, a method for uplink power control, a method for transmitting uplink channel transmissions, a user equipment and a base station. According to one of the embodiments the method for performing of the uplink power control comprises: receiving at least one control information; grouping at least one uplink channel transmission into at least one uplink channel power control group based on at least one information regarding power control included in the received control information, wherein transmission power of uplink channel transmissions included in one of the at least one uplink channel power control group are set to be same; and adjusting power of the at least one uplink channel power control group based on accumulated values of closed-loop power control corresponding each uplink channel power control group.

According to the method for determining uplink channel power control groups, the method for uplink power control, the method for transmitting uplink transmissions and the user equipment provided by the present disclosure, by determining a plurality of uplink channel transmission groups, uplink channel transmissions in each uplink channel transmission group having a same transmission power, various characteristics can be comprehensively calculated based on the information carried in the plurality of uplink channel transmission groups, and thus the accuracy of the calculation is improved.

### BRIEF DESCRIPTION OF THE DRAWINGS

Exemplary embodiments of the present disclosure are further described below with reference to the accompanying drawings.

Text and drawings are provided as examples only to help the readers understand the disclosure. They are not intended to and should not be interpreted to limit the scope of this disclosure in any manner. Although certain embodiments and examples have been provided, based on the disclosure herein, it will be obvious to those skilled in the art that changes can be made to the illustrated exemplary embodiments and examples without departing from the scope of the disclosure.

FIGS. 1-3 show schematic diagrams for calculating an accumulated value of closed-loop power control for PUSCH according to TPC command values.

FIG. 4 shows a schematic diagram for joint channel estimation based on DMRSs in the PUSCH at transmission occasion i and in the PUSCH at transmission occasion i-1.

FIGS. 5-7 show schematic diagrams for calculating an accumulated value of closed-loop power control for PUSCHs in PUSCH power control group (PPCG) g according to TPC command values, according to embodiments of the present disclosure.

FIGS. 8A-8B shows a flowchart of a method for transmitting uplink channel transmissions according to an embodiment of the present disclosure.

FIGS. 9-20 show schematic diagrams of a process for determining a PPCG according to embodiments of the present disclosure.

FIGS. 21A-21B respectively show schematic diagrams of a process for determining whether to transmit or not to transmit a certain PUSCH according to embodiments of the present disclosure.

FIG. 22 shows a structural block diagram of a user equipment according to an embodiment of the present disclosure.

FIG. 23 shows a structural block diagram of a base station according to an embodiment of the present disclosure.

### DETAILED DESCRIPTION

During an uplink channel transmission, it is required to adjust transmission power for the uplink channel transmission in time, and to meet a higher performance of the demodulation for the uplink channel at the same time.

According to an aspect of the present disclosure, there is provided a method of determining uplink channel power control groups, comprising: receiving at least one signaling; and grouping at least one uplink channel transmission into at least one uplink channel power control group by means of information included in the at least one signaling, wherein for each uplink channel power control group, the uplink channel transmissions included in the uplink channel power control group have the same transmission power.

In an exemplary embodiment, at least two uplink channel transmissions included in the uplink channel power control group include (carry) DMRSs, and the DMRSs are transmitted to a communication device such as a base station so that the communication device performs a joint channel estimation based on the DMRSs.

In an exemplary embodiment, the method further comprises: determining, for each uplink channel power control group, a maximum limit of a number of symbols in a DMRS design time unit (DDTU) in the uplink channel power control group, based on the at least one signaling and/or a number of symbols contained in the uplink channel power control group, wherein each DDTU includes a DMRS.

In an exemplary embodiment, the method further comprises: when a number of OFDM symbols contained in the uplink channel transmission (repetition) to be transmitted is less than or equal to K (e.g., K is equal to 1), deciding whether the uplink channel transmission to be transmitted belongs to the same uplink channel power control group as at least one other uplink channel transmission, and determining whether to transmit the uplink channel transmission according to the decision result. For example, in a case where the uplink channel transmission to be transmitted belongs to the same uplink channel power control group as other uplink channel transmissions, the uplink channel transmission to be transmitted is transmitted.

According to another aspect of the present disclosure, there is provided a method for uplink power control. The method comprises: grouping at least one uplink channel transmission into at least one uplink channel power control group; calculating, for each uplink channel power control group, an accumulated value of closed-loop power control for the uplink channel power control group, based on power control commands which are not later than K1 symbols before the start of a first uplink channel transmission in the uplink channel power control group and which have not been used, wherein K1 is a timing relationship for calculation for the accumulated value of closed-loop power control at a transmission occasion for the first uplink channel transmission; and adjusting power for uplink channel transmissions in respective uplink channel power control groups based on the accumulated values of closed-loop power control respectively corresponding to the respective uplink channel power control groups.

According to another aspect of the present disclosure, there is provided a method for transmitting uplink channel transmissions, comprising: grouping at least one uplink channel transmission into at least one uplink channel power control group; for each uplink channel power control group, calculating, an accumulated value of closed-loop power control for the uplink channel power control group, to adjust power for respective uplink channel transmissions in the uplink channel power control group based on the accumulated value of closed-loop power control; and transmitting the at least one uplink channel transmission respectively based on a transmission power corresponding to each uplink channel transmission.

According to another aspect of the present disclosure, there is provided a user equipment comprising: a transceiver; and a processor operatively coupled to the transceiver and arranged to perform the method as described above.

In order to make the objectives, technical solutions and advantages of the present disclosure clearer, various exemplary embodiments of the present disclosure are described below with reference to the drawings to further illustrate the present disclosure in detail.

The exemplary embodiments described herein are not meant to be limiting. Aspects of the present disclosure as generally described herein and shown in the drawings may be arranged, substituted, combined, separated and designed in various different configurations, all of which may be considered herein. In addition, unless indicated otherwise in the context, features shown in each drawing may be used in combination with each other. Therefore, the drawings should generally be regarded as an integral part of one or more general embodiments, but it should be understood that not all illustrated features are necessary for each embodiment.

In addition, although PUSCH (which can be used interchangeably with “PUSCH transmission” and “PUSCH channel” herein) is mainly taken as an example herein to describe a method for uplink channel transmission based on the above described power control and/or a user equipment performing the method, those skilled in the art can understand that the method for uplink channel transmission and/or user equipment according to embodiments of the present disclosure may be used for other suitable uplink channels such as PUCCH other than PUSCH.

To meet the increasing demand with respect to wireless data communication traffic since the deployment of 4th generation (4G) communication systems, efforts have been made to develop an advanced 5th generation (5G) system or pre-5G communication system. For this reason, the 5G or pre-5G communication system is also called a beyond 4G network communication system or post long term evolution (LTE) system.

In order to achieve a high data rate, the 5G communication system is implemented in ultra-high frequency millimeter wave (mmWave) bands, e.g., 60 GHz bands. To reduce propagation loss of radio waves and to increase the transmission range, technologies such as beamforming, massive multiple-input multiple-output (MIMO), full dimensional MIMO (FD-MIMO), array antenna, analog beamforming, and large-scale antennas are under discussion in 5G communication systems.

In addition, in 5G communication systems, based on advanced small cells, cloud radio access networks (RANs), ultra-dense networks, device to device (D2D) communication, wireless backhaul, moving networks, cooperative communication, coordinated multi-points (CoMP), reception-end interference cancellation and the like, developments for improvements on system network is underway.

In 5G communication systems, hybrid frequency-shift keying (FSK) and quadrature amplitude modulation (QAM) modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

According to existing specifications, in 5G NR systems, a determination for uplink power control includes the determination of the power for physical uplink shared channel (PUSCH), physical uplink control channel (PUCCH), sounding reference signal (SRS) and Physical Random Access Channel (PRACH) transmissions. The uplink power control for PUSCH, PUCCH, etc., is described in 3GPP specification 38.213.

In the uplink power control described above, a formula for calculating the power of PUSCH channel transmitted at a PUSCH transmission occasion i on active Uplink Bandwidth Part (UL BWP) b of carrier f for serving cell c is as follows, where definitions of respective parameters are defined in Chapter 7.1.1 of Release 16.1.0 of the 3GPP Specification 38.213:

[symbol]

Formula (1) includes a term of an accumulated value of closed-loop power control, for example, the accumulated value of the closed-loop power control for PUSCH channel can be expressed as f_{b,f,c}(i,l). f_{b,f,c}(i,l) indicates the accumulated value of the closed-loop power control for PUSCH channel at the PUSCH transmission occasion i on the active UL BWP b of the carrier f for the serving cell c, which may be directly indicated by a DCI format for scheduling PUSCH, or may be determined according to the following formula if not directly indicated by the DCI format:

$${f}_{b , f , c} \left(l\right) = {f}_{b , f , c} \left(l - {l}_{0}\right) + {\sum }_{m = 0}^{M - 1} {δ}_{P U S C H , b , f , c} \left(m\right) \qquad \text{(2)}$$

Respective parameters in Formula (2) are defined specifically in Chapter 7.1.1 of Release 16.1.0 of the 3GPP Specification 38.213, and the respective parameters in Formula (2) are briefly illustrated below:
f_{b,f,c}(i) is the accumulated value of closed-loop power control for PUSCH channel at a PUSCH transmission occasion i;
f_{b,f,c} (i - i₀) is the accumulated value of closed-loop power control for PUSCH channel at a PUSCH transmission occasion i - i₀;
δ_{PUSCH,b,f,c}(m) is a TPC (Transmission Power Control) command value for the m-th PUSCH transmission occasion;

$${\sum }_{m = 0}^{M - 1} {δ}_{P U S C H , b , f , c} \left(m\right)$$
is a sum of TPC command values, that is, a sum of all M TPC command values received by the UE within a time interval T, where the time interval T is an interval between K_{PUSCH} (i -i₀) 1 symbols before the PUSCH transmission occasion i - i₀ and K_{PUSCH}(i) symbols before the PUSCH transmission occasion i.

K_{PUSCH}(i) is a timing relationship for calculation for the accumulated value of closed-loop power control for PUSCH transmission transmitted at the transmission occasion i. When the PUSCH transmission is scheduled by the DCI format, K_{PUSCH}(i) is the number of symbols for active UL BWP b of carrier c after the last symbol of a corresponding PDCCH reception and before the first symbol of the PUSCH transmission. When the PUSCH transmission is allocated by configured grant (CG), K_{PUSCH}(i) is a product of a number of symbols per slot and a minimum value of values provided by k2 in PUSCH-ConfigCommon for active UL BWP b of the serving cell c. Only TPC commands which are not later than K_{PUSCH}(i) OFDM symbols before the start of PUSCH transmitted at the transmission occasion i may be used for calculation for the accumulated value of closed-loop power control for the PUSCH transmitted at the transmission occasion i, while TPC commands which are later than K_{PUSCH} (i) OFDM symbols before the start of PUSCH transmitted at the transmission occasion i cannot be used for calculation for the accumulated value of closed-loop power control for the PUSCH transmitted at the transmission occasion i, since they don’t meet the latency requirement.

iₒ is the smallest integer such that K_{PUSCH}(i - i₀) symbols before the PUSCH transmission occasion i - i₀ is earlier than K_{PUSCH} (i) symbols before the PUSCH transmission occasion i, and is greater than 0.

More details about Formula (2) can be obtained from the 3GPP Specification 38.213, so they will not be described in detail here.

On the other hand, demodulation reference signals (DMRSs) can be transmitted parasitically on the uplink channel (PUSCH or PUCCH), which can be used for uplink data demodulation and uplink channel estimation.

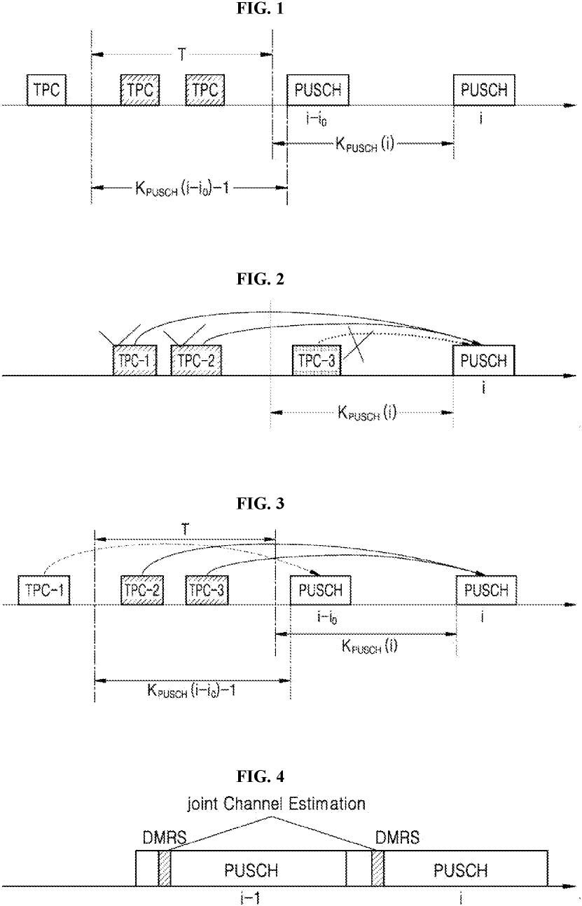

FIGS. 1-3 show a principle for calculating an accumulated value of closed-loop power control for PUSCH according to TPC command values.

Firstly, as previously mentioned, f_{b,f,c} (i) is the accumulated value of closed-loop power control for PUSCH channel at the PUSCH transmission occasion i; f_{b,f,c}(i – i₀) is the accumulated value of closed-loop power control for PUSCH channel at the PUSCH transmission occasion i – i₀; δ_{PUSCH,b,f,c}(m) is the TPC command value used for the m-th PUSCH transmission occasion;

$${\sum }_{m = 0}^{M - 1} {δ}_{P U S C H , b , f , c} \left(m\right)$$

is the sum of transmission power control (TPC) command values, that is, the sum of all M TPC command values received by the UE within K_{PUSCH}(i – i₀) – 1 a time interval T, where the time interval T is an interval between symbols before the PUSCH transmission occasion i - i₀ and K_{PUSCH}(i) symbols before the PUSCH transmission occasion i.

As shown in FIG. 1, two TPC command values within a time interval T are used for calculation for the accumulated value of closed-loop power control for PUSCH transmitted at the transmission occasion i. The PUSCH transmitted at the PUSCH transmission occasion i may be a newly transmitted PUSCH, a retransmitted PUSCH or a PUSCH repetition. As previously mentioned, K_{PUSCH} (i) is the timing relationship for calculation for the accumulated value of closed-loop power control for PUSCH transmitted at the transmission occasion i. That is, only TPC commands which are not later than K_{PUSCH}(i) symbols (hereinafter, sometimes also referred to as OFDM symbols) before the start of PUSCH transmitted at the transmission occasion i may be used for calculation for the accumulated value of closed-loop power control for PUSCH transmitted at the transmission occasion i, while TPC commands which are later than K_{PUSCH}(i) OFDM symbols before the start of PUSCH transmitted at the transmission occasion i cannot be used for calculation for the accumulated value of closed-loop power control for PUSCH transmitted at the transmission occasion i, since they don’t meet the latency requirement. In addition, even if the latency requirement is met, the TPC commands which have been used to calculate the accumulated value of closed-loop power control for other PUSCH transmissions are also not used to calculate the accumulated value of closed-loop power control for PUSCH transmitted at the transmission occasion i.

As shown in FIG. 2, two TPC command values, TPC-1 and TPC-2, are not later than K_{PUSCH}(i) OFDM symbols before the start of PUSCH transmitted at the transmission occasion i, so TPC-1 and TPC-2 may be used for calculation for the accumulated value of closed-loop power control for PUSCH transmitted at the transmission occasion i. The TPC command value, TPC-3, is later than K_{PUSCH}(i) OFDM symbols before the start of PUSCH transmitted at the transmission occasion i, so TPC-3 cannot be used for calculation for the accumulated value of closed-loop power control for PUSCH transmitted at the transmission occasion i.

In addition, as shown in FIG. 3, none of the three TPC command values, TPC-1, TPC-2 and TPC-3, is later than K_{PUSCH}(i) OFDM symbols before the start of PUSCH transmitted at the transmission occasion i. According to similar latency requirements for processing TPC commands, all of TPC-1, TPC-2 and TPC-3 may be used for calculation for the accumulated value of closed-loop power control for PUSCH transmitted at the transmission occasion i. However, since TPC-1 is not later than K_{PUSCH}(i – i₀) OFDM symbols before the start of PUSCH transmitted at the transmission occasion i - i₀, that is, TPC-1 has been applied for calculation for the accumulated value of closed-loop power control for PUSCH transmitted at the transmission occasion i – i₀ and _{PUSCH} transmitted at the transmission occasion i – i₀ is earlier than PUSCH transmitted at the transmission occasion i, therefore, TPC-1 is not repeatedly applied for calculation for the accumulated value of closed-loop power control for PUSCH transmitted at the transmission occasion i.

It should be noted that, the above-mentioned PUSCH transmission may be a dynamically scheduled PUSCH transmission, that is, a PUSCH transmission scheduled by Downlink Control Information (DCI), which is referred as a dynamic grant (DG) PUSCH transmission. The above-mentioned PUSCH transmission may also be a configured grant (CG) PUSCH transmission. TPC commands may be the TPC commands in TPC command fields of the DCIs which are used for scheduling PUSCH (e.g., TPC commands in DCI format 0_1), or the TPC commands in TPC command fields of the DCIs which are not used for scheduling PUSCH, that is, group-common TPC commands (e.g., TPC commands in DCI format 2_2).

Each PUSCH transmission occasion mentioned above is an individual unit for calculating the accumulated value of closed-loop power control. In addition, in order to improve the accuracy of the channel estimation based on demodulation reference signals (DMRSs), a joint channel estimation may be performed based on DMRSs in a plurality of (i.e., at least two) PUSCHs transmitted at more than one PUSCH transmission occasions, which may increase the accuracy of the channel estimation and thus improve the performance of bit error rate for demodulating PUSCH.

For the plurality of PUSCH transmissions at the plurality of transmission occasions for joint channel estimation, in order to ensure that DMRSs for joint channel estimation can be better used for demodulation for the plurality of PUSCH transmissions at the plurality of transmission occasions, the transmission power for the plurality of PUSCH transmissions at the plurality of transmission occasions should not change, that is, when DMRSs in the plurality of PUSCH transmissions at the plurality of transmission occasions are used for joint channel estimation, the transmission power for the plurality of PUSCH transmissions at the plurality of transmission occasions is the same.

FIG. 4 shows a schematic diagram for joint channel estimation based on DMRSs in PUSCH at the transmission occasion i and PUSCH at the transmission occasion i-1. Although FIG. 4 only schematically shows that joint channel estimation is performed based on DMRSs in two PUSCHs transmitted at two transmission occasions, it should be clear to those skilled in the art that joint channel estimation may be performed based on a plurality of DMRSs in PUSCHs transmitted at more transmission occasions, which is not limited by this disclosure.

The PUSCH transmission (occasion) described herein may be a newly transmitted PUSCH transmission (occasion), a retransmitted PUSCH transmission (occasion), or a PUSCH transmission repetition (occasion). The PUSCH transmission repetition (occasion) may be one nominal PUSCH transmission repetition (occasion), or one actual PUSCH transmission repetition (occasion) of more than one actual PUSCH transmission repetitions (occasions) partitioned from one nominal PUSCH transmission repetition (occasion).

As previously mentioned, in order to ensure that DMRSs for joint channel estimation can be better used for demodulation for PUSCH transmissions (also directly referred to as PUSCH) at a plurality of transmission occasions, the transmission powers for the plurality of PUSCH transmissions at the plurality of transmission occasions corresponding to DMRSs on which the joint channel estimation is based should be the same. Therefore, the exemplary embodiments of the present disclosure further present a concept of uplink channel power control group. The PUSCH power control group (PPCG) is mainly taken as an example herein, while other suitable uplink channel power control groups are also feasible. Each PPCG may contain a plurality of PUSCH transmissions transmitted at more than one transmission occasions, and at all PUSCH transmission occasions corresponding to all PUSCH transmissions in the PPCG, the same accumulated value of closed-loop power control is used to adjust the transmission power for the corresponding PUSCH transmissions, so that for each PPCG, a user equipment (UE) can transmit all PUSCH transmissions in the PPCG with the same adjusted transmission power. That is, the accumulated value of closed-loop power control is calculated with PPCG as an individual unit. Each PPCG may also be expressed as containing a plurality of PUSCH transmission occasions.

Therefore, in the exemplary embodiments of the present disclosure, PPCG is used instead of PUSCH transmission occasion to calculate the accumulated value of closed-loop power control, and thus Formula (2) may be modified as follows.

On the basis of Formula (1), it can be derived that the accumulated value of closed-loop power control for PUSCHs in PPCG g on the active uplink bandwidth part (UL BWP) b of the carrier f of the serving cell c is determined according to the following formula:

$${f}_{b , f , c} \left(g\right) = {f}_{b , f , c} \left(g - {g}_{0}\right) + {\sum }_{m = 0}^{M - 1} {δ}_{P U S C H , b , f , c} \left(m , l\right) \qquad \text{(3)}$$

Similar to the definition of parameters in Formula (2), the parameters in Formula (3) are briefly described as follows:
f_{b,f,c}(g) is the accumulated value of closed-loop power control for PUSCHs of PPCG g;
f_{b,f,c}(g – g₀) is the accumulated value of closed-loop power control for PUSCHs of PPCG g – g₀;
δ_{PUSCH,b,c}(m) is the TPC command value for the m-th PUSCH transmission occasion;

$${\sum }_{m = 0}^{M - 1} {δ}_{P U S C H , b , f , c} \left(m\right)$$
is the sum of TPC command values, that is, the sum of all TPC command values received by the UE within a time interval T, where the time interval T is an interval in time domain between K_{PUSCH} (g - g₀) - 1 symbols before PPCG g - g₀ and K_{PUSCH}(g) symbols before PPCG g.

K_{PUSCH}(g) is the timing relationship for calculation for the accumulated value of closed-loop power control for PUSCH at the first PUSCH transmission occasion Pin PPCG g. Only TPC commands which are not later than K_{PUSCH} (p) OFDM symbols before the start of PUSCH transmitted at the first PUSCH transmission occasion p in PPCG g may be used for calculation for the accumulated value of closed-loop power control for PUSCHs in PPCG g, while TPC commands which are later than K_{PUSCH} (p) OFDM symbols before the start of PUSCH transmitted at the first transmission occasion p in PPCG g cannot be used for calculation for the accumulated value of closed-loop power control for PUSCHs in PPCG g, because the latency requirement is not met or because of the requirements of the precision of the channel estimation.

g₀ is the smallest integer such that K_{PUSCH}(q) symbols before the first PUSCH transmission occasion q in PPCG g - g₀ is earlier than K_{PUSCH}(p) symbols before the first PUSCH transmission occasion p in PPCG g, and is greater than 0.

FIGS. 5-7 show schematic diagrams for calculating an accumulated value of closed-loop power control for PUSCHs in PPCG g according to TPC command values.

As shown in FIG. 5, two TPC command values within the time interval T are used for calculation for the accumulated value of closed-loop power control for PUSCHs in PPCG g. As previously mentioned, K_{PUSCH} (g) is the timing relationship for calculation for the accumulated value of closed-loop power control for PUSCH transmitted at the first PUSCH transmission p in PPCG g. That is, only TPC commands which are not later than K_{PUSCH} (p) OFDM symbols before the start of PUSCH transmitted at the first PUSCH transmission occasion p in PPCG g may be used for calculation for the accumulated value of closed-loop power control for PUSCHs in PPCG g, while TPC commands which are later than K_{PUSCH}(p) OFDM symbols before the start of PUSCH transmitted at the first transmission occasion p in PPCG g cannot be used for calculation for the accumulated value of closed-loop power control for PUSCH transmitted in PPCG g, because the latency requirement is not met or because of the requirements of the precision of channel estimation.

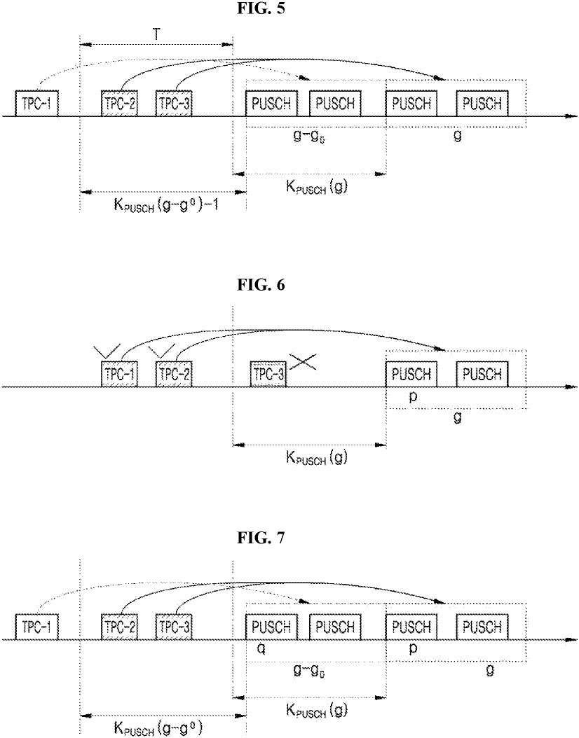

As shown in FIG. 6, the two TPC command values, TPC-1 and TPC-2, are not later than K_{PUSCH} (p) OFDM symbols before the start of PUSCH transmitted at the first PUSCH transmission occasion p in PPCG g, so TPC-1 and TPC-2 may be used for calculation for the accumulated value of closed-loop power control for PUSCHs in PPCG g. TPC-3 is later than K_{PUSCH}(p) OFDM symbols before the start of PUSCH transmitted at the first PUSCH transmission occasion in PPCG g, so TPC-3 cannot be used for calculation for the accumulated value of closed-loop power control for PUSCHs in PPCG g.

In addition, as shown in FIG. 7, none of TPC-1, TPC-2 and TPC-3 is later than K_{PUSCH}(p) symbols before the start of PUSCH transmitted at the first PUSCH transmission occasion p in PPCG g. According to the latency requirement for processing TPC commands, all of TPC-1, TPC-2 and TPC-3 may be used for calculation for the accumulated value of closed-loop power control for PUSCHs in PPCG g. Since TPC-1 is not later than K_{PUSCH}(q) symbols before the start of PUSCH transmitted at the first PUSCH transmission occasion q in PPCG g – g₀, and all PUSCHs in PPCG g – g₀ are transmitted earlier than PUSCH transmitted at the first PUSCH transmission occasion p in PPCG g, so TPC-1 has been applied for calculation for the accumulated value of closed-loop power control for PUSCHs in PPCG g – g_{0.} Therefore, TPC-1 would not be repeatedly applied for calculation for the accumulated value of closed-loop power control for PUSCHs in PPCG g.

To sum up, an aspect of the present disclosure provides a method 800 for uplink power control. The method 800 includes the following steps.

At step S801, at least one uplink channel transmission is grouped into at least one uplink channel power control group.

For example, the uplink channel transmission may be PUSCH transmission or PUCCH transmission.

In addition, more details of step S801 will be described in detail later with reference to the drawings.

At step S802, for each uplink channel power control group, the accumulated value of closed-loop power control for the uplink channel power control group (i.e., for the uplink transmissions in the group) is calculated based on power control commands which are not later than K1 symbols before the start of a first uplink channel transmission in the uplink channel power control group and which have not been used, wherein K1 is a timing relationship for calculation for the accumulated value of closed-loop power control for the first uplink channel transmission transmitted at an first uplink channel transmission occasion in the uplink channel power control group.

At step S803, power for uplink channel transmissions in respective uplink channel power control groups is adjusted based on the accumulated values of closed-loop power control respectively corresponding to respective uplink channel power control groups.

After understanding the above concept of PPCG and the method for uplink power control, another aspect of the present disclosure provides a method for transmitting uplink channel transmissions.

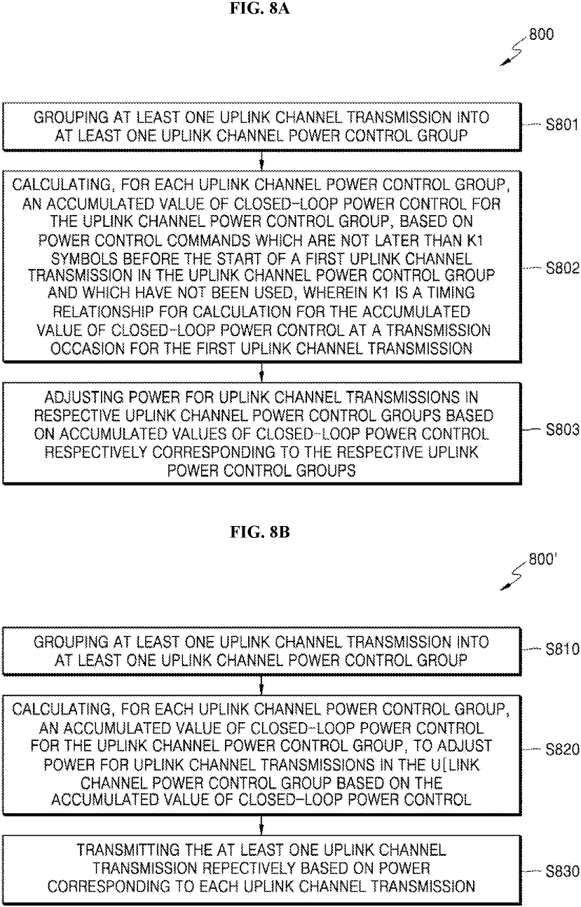

FIG. 8B shows a method 800′ for transmitting uplink channel transmission according to an embodiment of the present disclosure, which is performed by a user equipment (UE). The method 800′ may include the following steps.

At step S810, at least one uplink channel transmission is grouped into at least one uplink channel power control group. According to an embodiment of the present disclosure, the UE may obtain at least one information regarding power control via higher layer signaling or MAC signaling or physical layer signaling or a combination of at least one aforementioned signaling. The UE may group the at least one uplink channel transmission into the at least one uplink channel power control group based on the obtained information regarding power control.

At step S820, for each uplink channel power control group, an accumulated value of closed-loop power control for the uplink channel power control group (i.e., for the uplink transmissions in the group) is calculated to adjust power for uplink channel transmissions in the uplink channel power control group based on the accumulated value of closed-loop power control.

For example, calculating the accumulated value of closed-loop power control for the uplink channel power control group may be performed with the method described with reference to FIGS. 5-7.

At step S830, the at least one uplink channel transmission is transmitted respectively based on the power corresponding to each uplink channel transmission.

In addition, as previously analyzed, since the power for all PUSCHs transmissions within one PPCG should be the same, DMRSs carried in at least a part of successively transmitted PUSCH transmissions in the PPCG may also be provided to a communication device such as a base station, so that the communication device may perform joint channel estimation based on the DMRSs. In this way, it can be ensured that DMRSs used for joint channel estimation can be better used for demodulation for uplink channels at a plurality of transmission occasions, and the performance of the demodulation for uplink channels can be improved. Meanwhile, on the premise of guaranteeing the performance of the demodulation based on DMRSs used for joint channel estimation, it can be ensured that the power control command can be used to adjust the transmission power for uplink channel transmissions as timely as possible.

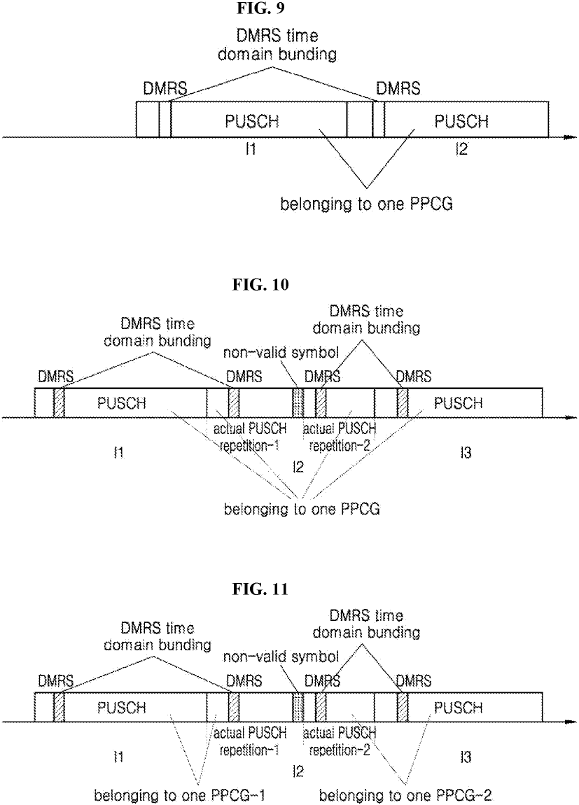

With reference to FIGS. 5-7, a principle for how to calculate an accumulated value of closed-loop power control for PUSCHs according to PPCG as time unit is described in the foregoing. A process for grouping the at least one uplink transmission with respect to the power control group (i.e., determining uplink channel power control groups, e.g., PPCGs), i.e., more details of S801 in method 800 and S810 in method 800′, will be described in conjunction with FIGS. 9-21.

The UE can determine the PPCGs by receiving an explicit signaling, an implicit signaling or a combination of the implicit signaling and the explicit signaling. That is, the method for determining uplink channel power control groups comprises: receiving at least one signaling; and grouping the at least one uplink channel transmission into at least one uplink channel power control group based on the at least one signaling, wherein for each uplink channel power control group, uplink channel transmissions included in the uplink channel power control group have the same transmission power.

The explicit signaling includes higher layer signaling, Media Access Control (MAC) signaling, physical layer signaling (including the information field in DCI, which may be the information field in DCI for scheduling PUSCH, or the information field in dedicated DCI, or the information field in DCI for activating CG PUSCH), and so on. The implicit signaling includes Time Domain Resource Assignment (TDRA) for PUSCH, DMRS time domain bundling indication information, DMRS time domain sharing indication information, PUSCH repetition indication information, non-valid uplink symbol pattern indication information, and so on.

In the present disclosure, time unit is identified based on at least one of repetitions, slots or symbols. For convenience of explanation, in some embodiments, the time unit may be specified as the slots or the repetitions or the symbols, but this is merely an embodiment.

The PUSCH (or PUSCH transmission) described herein may be PUSCH repetition (meaning that different PUSCHs transmit the same transport block) or individual PUSCH (meaning that different PUSCHs transmit different transport blocks). The PUSCH repetition may be one nominal PUSCH repetition, or one actual PUSCH repetition of more than one actual PUSCH repetition partitioned from one nominal PUSCH repetition.

In an embodiment of the present disclosure, PPCGs are determined according to the DMRS time domain bundling indication information for PUSCH (illustrated in detail by means of Manner I and Manner II below).

### Manner I

The PUSCHs for at least two transmission occasions on which DMRS time domain bundling is performed belong to one DMRS time bundling group (DTBG), that is, DMRSs carried in all PUSCHs in one DTBG are used for joint channel estimation. The PUSCHs belonging to one DTBG are grouped into one PPCG, that is, all the PUSCHs in one PPCG belong to one DTBG, and different DTBGs belong to different PPCGs.

As shown in FIG. 9, DMRS time domain bundling is performed on PUSCH at transmission occasion l1 and PUSCH at transmission occasion l2, the two PUSCHs belonging to one DTBG, and PUSCH at transmission occasion l1 and PUSCH at transmission occasion l2 belong to one PPCG.

Employing Manner I is advantageous in that because DMRSs in at least two PUSCHs on which DMRS time domain bundling is performed are to be used for joint channel estimation. If the power for the at least two PUSCHs, on which DMRS time domain bundling is performed, is different, a phase deviation will occur between the channel characteristics derived from DMRS joint channel estimation and the actual channel characteristics of each PUSCH, which will affect the demodulation for PUSCH. In contrast, in case that the at least two PUSCHs on which DMRS time domain bundling is performed utilize the same power, no phase derivation will occur between the channel characteristics derived from DMRS joint channel estimation and the actual channel characteristics of each PUSCH, and the precision of the DMRS joint channel estimation is higher than that of the DMRS independent channel estimation for each PUSCH. Thus, the performance of the demodulation for PUSCH is improved.

### Manner II

The PUSCHs for at least two transmission occasions on which DMRS time domain bundling is performed belong to one DTBG, and one PPCG may contain more than one DTBG.

For example, when the PUSCH at one transmission occasion is partitioned into two parts and these two parts do not belong to one DTBG. For example, as previously mentioned, the PUSCH may be an independent PUSCH or a PUSCH repetition. In case that the PUSCH is a PUSCH repetition, the PUSCH repetition may be one nominal PUSCH repetition, or one actual PUSCH repetition of more than one actual PUSCH repetition partitioned from one nominal PUSCH repetition. As an example, one nominal PUSCH repetition is partitioned into two actual PUSCH repetitions, and each actual PUSCH repetition as well as PUSCHs at other transmission occasions belong to one DTBG.

When the PUSCHs in two DTBGs include different actual PUSCH repetitions belonging to one nominal PUSCH repetition, the two DTBGs are grouped into one PPCG. The transmission power for PUSCHs in the two DTBGs is calculated (adjusted) by utilizing the same accumulated value of closed-loop power control.

This will be better illustrated with reference to FIG. 10. As shown in FIG. 10, the nominal PUSCH repetition at transmission occasion l2 is partitioned into two actual PUSCH repetitions, namely a first actual PUSCH repetition (actual PUSCH repetition-1) and a second actual PUSCH repetition (actual PUSCH repetition-2), where the first actual PUSCH repetition and the nominal PUSCH repetition at transmission occasion 11 constitute a first DTBG, and the second actual PUSCH repetition and the nominal PUSCH repetition at transmission occasion 13 constitute the second DTBG. The first DTBG and the second DTBG belong to one PPCG. The actual PUSCH repetitions in the same nominal PUSCH repetition utilize the same power.

In addition, in case that the PUSCHs in two DTBGs include different actual PUSCH repetitions belonging to one nominal PUSCH repetition, the two DTBGs are respectively grouped into two different PPCGs, that is, the transmission power for PUSCHs in each of the two DTBGs is calculated (adjusted) by utilizing the accumulated values of the closed-loop power control for respective PPCGs.

This will be better illustrated with reference to FIG. 11. As shown in FIG. 11, the nominal PUSCH repetition at transmission occasion l2 is partitioned into two actual PUSCH repetitions, namely a first actual PUSCH repetition (actual PUSCH repetition-1) and a second actual PUSCH repetition (actual PUSCH repetition-2), where the first actual PUSCH repetition and the nominal PUSCH repetition at transmission occasion 11 constitute a first DTBG, and the second actual PUSCH repetition and the nominal PUSCH repetition at transmission occasion 13 constitute a second DTBG. The first DTBG belongs to the first PPCG (PPCG-1) and the second DTBG belongs to the second PPCG (PPCG-2).

In Manner II, because at least one PPCG is determined according to DMRS time domain bundling, DMRSs carried in a plurality of PUSCHs in each PPCG may be used for joint channel estimation.

Employing Manner II is advantageous in that on the premise of guaranteeing the precision of the DMRS joint channel estimation, the accumulated value of closed-loop power control may be updated according to TPC commands as timely as possible, so that power control may be more effective.

The above describes a method for determining PPCGs based on performing DMRS time domain bundling on DMRSs carried in successive PUSCHs, and PPCGs can also be determined based on DMRS time domain sharing. The said DMRS time domain sharing means that in case that there may be no DMRSs in a certain time unit, and DMRSs in other time unit should be used for demodulation. For example, if there is a DMRS in the PUSCH of time slot n and there are no DMRSs in the PUSCH of time slot n+1, the channel estimation may be performed using DMRSs in the PUSCH of time slot n. The PUSCH of time slot n+1 may be demodulated based on the channel estimation performed using DMRSs in the PUSCH of time slot n. In this case, the UE may receive the DMRS time domain sharing indication information from the higher layer signaling or MAC signaling or physical layer signaling or a combination of at least one of aforementioned signaling. The UE may group the PUSCHs on which the DMRS time domain sharing is to be performed (e.g., PUSCHs of time slot n and time slot n+1) into one PPCG according to the DMRS time domain sharing indication information. The principle of the implementation is similar to DMRS time domain bundling, so it will not be described in detail here.

In another exemplary embodiment of the present disclosure, a plurality of PUSCHs are scheduled by means of DCI, and PPCGs are determined according to the DCI which schedules PUSCH (illustrated in detail by Manner III below).

Specifically, which PUSCHs can be scheduled by DCI may be determined based on the DCI. All PUSCHs scheduled by one DCI may be grouped into one PPCG, or all PUSCHs scheduled by one DCI may be grouped into at least two PPCGs.

It should be noted that, as previously mentioned, the PUSCH described herein may be a PUSCH repetition or an independent PUSCH.

### Manner III

In an embodiment of the present disclosure, all PUSCHs scheduled by one DCI are grouped into one PPCG. The transmission power for all PUSCHs scheduled by one DCI is calculated (adjusted) by utilizing the same accumulated value of closed-loop power control. The number of PUSCHs scheduled by each DCI is configured by the higher layer signaling or indicated by a field in the DCI which schedules PUSCHs. As shown in FIG. 12, all of PUSCH-1, PUSCH-2, PUSCH-3 and PUSCH-4 belong to (are grouped into) the same PPCG.

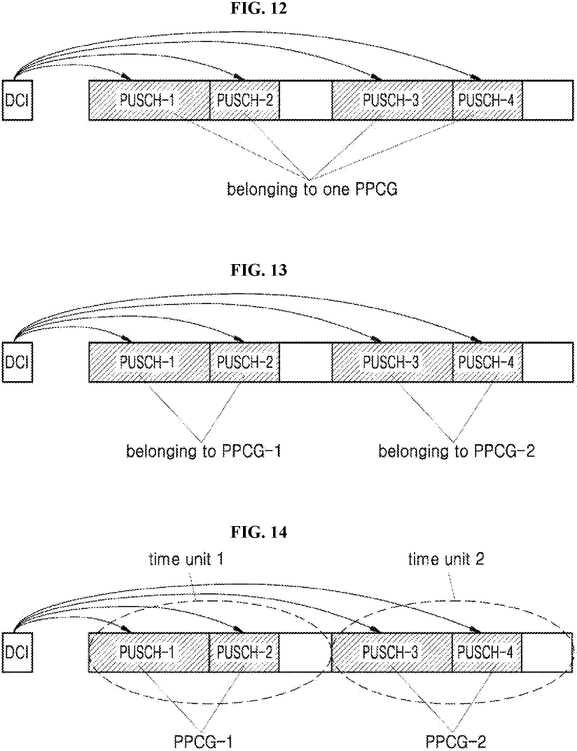

Alternatively, the successive PUSCHs of all PUSCHs scheduled by one DCI are grouped into one PPCG. As shown in FIG. 13, PUSCH-1 and PUSCH-2 are successive and belong to PPCG-1, PUSCH-2 and PUSCH-3 are not successive, and PUSCH-3 and PUSCH-4 are successive and belong to PPCG-2.

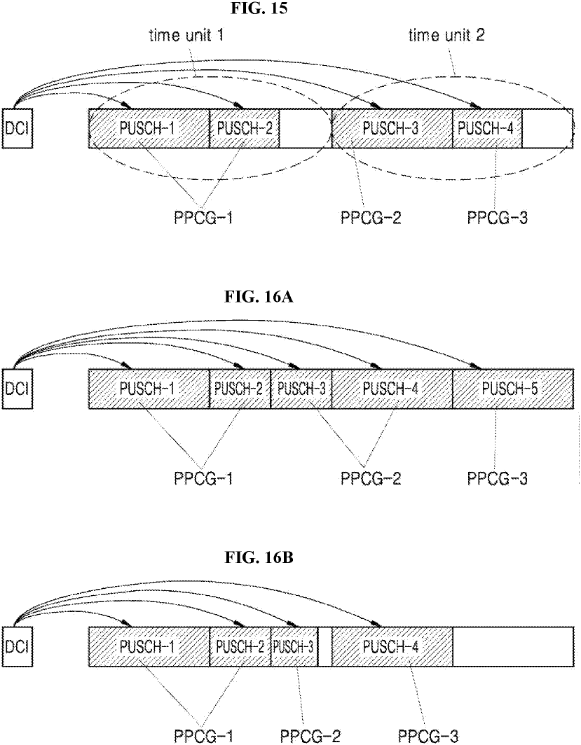

Alternatively, all PUSCHs scheduled by one DCI are grouped into different PPCGs according to time units (e.g., one time unit may be L time slots, and L may be obtained through receiving signaling by the UE, for example, L may be obtained through receiving higher layer signaling configuration by the UE; and one time unit may also be P OFDM symbols, and P may be obtained through receiving signaling by the UE, for example, P may be obtained through receiving higher layer signaling configuration by the UE). The PUSCHs belonging to one PPCG may be a plurality of PUSCHs within one time unit. For example, as shown in FIG. 14, one DCI schedules four PUSCHs, and there is one PUSCH in each time slot. L may be equal to 2. In this case, the PUSCH within the first time slot and the PUSCH within the second time slot may be grouped into PPCG-1, and the PUSCH within the third time slot and the PUSCH within the fourth time slot may be grouped into PPCG-2.

Alternatively, considering whether the PUSCHs within one time unit which are scheduled by one DCI are successive or not, each set of successive PUSCHs are grouped into one corresponding PPCG. As shown in FIG. 15, PUSCH-1 and PUSCH-2 are located in time unit 1 and are successive, so PUSCH-1 and PUSCH-2 are grouped into PPCG-1. Also, PUSCH-3 and PUSCH-4 are located in time unit 2 but are not successive, so PUSCH-3 is grouped into PPCG-2, and PUSCH-4 is grouped into PPCG-3.

Alternatively, the at least one uplink channel transmission is grouped into at least one uplink channel power control group according to preset parameter values.

For example, considering a first preset number N1 of PUSCH transmissions belonging to one PPCG, all PUSCHs scheduled by one DCI are grouped into at least one PPCG, where the first preset number N1 of PUSCH transmissions belonging to one PPCG may be obtained through receiving signaling by the UE (e.g., N1 may be obtained through receiving higher layer signaling configuration by the UE, or N1 may be obtained through receiving physical layer signaling by the UE, for example, it may be indicated by a field in the DCI which schedules PUSCHs). For example, as shown in FIG. 16A, one DCI schedules 5 PUSCHs, and N1 is equal to 2. In this case, a first PUSCH (PUSCH-1) and a second PUSCH (PUSCH-2) belong to PPCG-1, a third PUSCH (PUSCH-3) and a fourth PUSCH (PUSCH-4) belong to PPCG-2, and a fifth PUSCH (PUSCH-5) belongs to PPCG-3. Alternatively, considering a second preset number N2 of successive PUSCH transmissions belonging to one PPCG, N2 successive PUSCHs scheduled by one DCI are grouped into one PPCG. For example, as shown in FIG. 16B, e.g., N2 is equal to 2, and PUSCH-1. PUSCH-2 and PUSCH-3 are successive, so PUSCH-1 and PUSCH-2 belong to PPCG-1. Also, PUSCH-3 and PUSCH-4 are not successive, so PUSCH-3 belongs to PPCG-2, and PUSCH-4 belongs to PPCG-3.

In addition, the above Manner III may also be used to determine DTBGs, except that the successive PUSCHs in a PPCG are replaced by the successive PUSCHs in a DTBG. That is, a plurality of PUSCHs scheduled by DCI are grouped into a plurality of DTBGs using the above method, so that for each DTBG, joint channel estimation is performed by employing DMRSs carried in the PUSCHs included in the DTBG.

According to another exemplary embodiment of the present disclosure, PPCGs are determined according to the DCI which schedules PUSCHs. In this embodiment, the PUSCH repetition is illustrated as an example of PUSCH, and the PUSCH repetition may be either the nominal PUSCH repetition or the actual PUSCH repetition. However, obviously, the process for determining PPCGs according to this embodiment may also be applied to individual PUSCHs as appropriate (which will be illustrated in detail by Manner IV, Manner V and Manner VI below).

### Manner IV

Considering a third preset number N3 of successive PUSCH repetitions belonging to one PPCG, a plurality of PUSCH repetitions scheduled by one DCI are grouped into at least one PPCG, where the number of PUSCH repetitions belonging to one PPCG is less than or equal to N3 (as previously mentioned, N3 may be obtained through receiving higher layer signaling or MAC signaling by the UE, or N3 may be obtained through receiving physical layer signaling (e.g., the physical layer signaling is the information in the DCI which schedules PUSCHs) by the UE), and the PUSCH repetitions belonging to one PPCG are successive in time domain.

Specifically, starting from the first PUSCH repetition scheduled by DCI, N3 successive PUSCHs repetitions in sequential order are as one PPCG. If after M (M is less than N3) successive PUSCH repetitions, there is a PUSCH repetition which is not successive with the M-th PUSCH repetition (e.g., there is an unavailable OFDM symbol after the M-th PUSCH repetition).,The M successive PUSCH repetitions are grouped into one PPCG. Then starting from the (M+1)-th PUSCH repetition, N3 successive PUSCH repetitions in sequential order are grouped into one PPCG, and so on until the last PUSCH repetition scheduled by DCI is grouped. The PUSCH repetition herein is the actual PUSCH repetition (e.g., if a nominal PUSCH repetition is partitioned into two actual PUSCHs and the two actual PUSCHs are not successive, the nominal PUSCH repetition is regarded as two PUSCH repetitions), that is, each PUSCH repetition includes successive OFDM symbols.

For example, as shown in FIG. 17, N3 is equal to 3, and DCI schedules 6 nominal PUSCH repetitions (the indexes for the nominal PUSCH repetitions are marked as 1-6 in this figure), where the 5th nominal PUSCH repetition is partitioned into 2 actual PUSCH repetitions, so there are 7 PUSCH repetitions in total (the indexes for PUSCH repetitions are marked as 1-7 in this figure). Starting from the first PUSCH repetition, the three successive PUSCH repetitions in sequential order (the first PUSCH repetition, the second PUSCH repetition and the third PUSCH repetition) are grouped into the first PPCG (PPCG-1). Starting from the fourth PUSCH repetition, there are only two successive PUSCH repetitions in sequential order (the fourth PUSCH repetition and the fifth PUSCH repetition), which are grouped into the second PPCG (PPCG-2). Also, starting from the sixth PUSCH repetition, there are only two successive PUSCH repetitions in sequential order (the sixth PUSCH repetition and the seventh PUSCH repetition), which are grouped into the third PPCG (PPCG-3).

This Manner IV takes the actual PUSCH repetition as the basic unit for constituting a PPCG. Employing this method can adjust the power as timely as possible according to power control commands on the premise of guaranteeing the performance of channel estimation.

Again, this manner may also be used to determine DTBGs, except that the successive PUSCH repetitions in a PPCG are replaced by the successive PUSCH repetitions in a DTBG. That is, a plurality of PUSCH repetitions scheduled by DCI are grouped into a plurality of DTBGs using the above method, so that for each DTBG, joint channel estimation is performed by employing DMRSs carried in the PUSCH repetitions included in the DTBG.

### Manner V

Considering a fourth preset number N4 of PUSCHs (or PUSCH repetitions, this Manner V may be applied to individual PUSCHs or PUSCH repetitions, and hereinafter PUSCH repetitions will be taken as an example) belonging to one PPCG, a plurality of PUSCH repetitions scheduled by one DCI are grouped into at least one PPCG, where the number of PUSCH repetitions belonging to one PPCG is less than or equal to N4 (as previously mentioned. N4 may be obtained through receiving higher layer signaling or MAC signaling by the UE, or N4 may be obtained through receiving physical layer signaling (e.g., the physical layer signaling is the information in the DCI which schedules PUSCHs) by the UE). The PUSCH repetitions belonging to one PPCG are successive in time domain. In addition, in order to guarantee the accuracy of the joint channel estimation for PUSCHs in each PPCG, the numbers of PUSCH repetitions included in each PPCG may be uniform among a plurality of PPCGs grouped from a plurality of PUSCH repetitions which are mutually successive (hereinafter referred to as a successive PUSCH repetition group). The “uniform” herein means “as much uniform as possible”, but not necessarily “absolutely uniform”.

Specifically, at first, a successive PUSCH repetition group is determined.

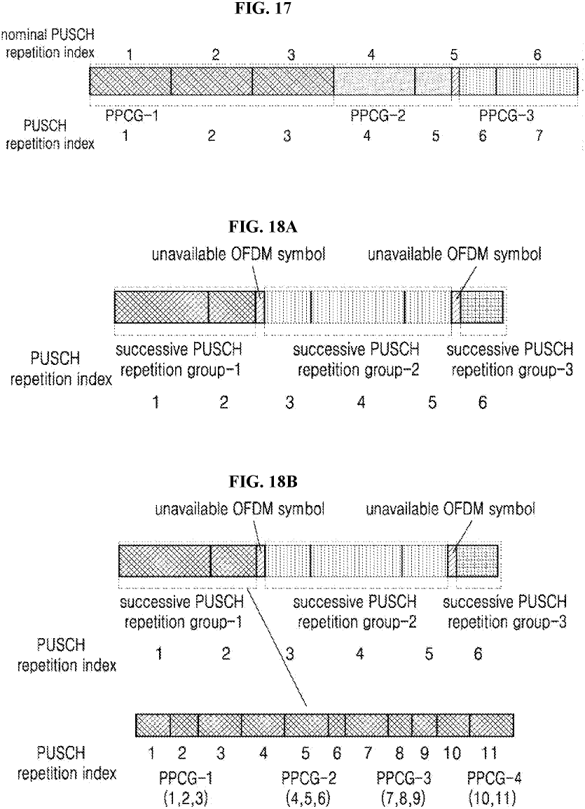

A successive PUSCH repetition group means that the PUSCH repetitions in the successive PUSCH repetition group are mutually successive, and different successive PUSCH repetition groups are not mutually successive. For example, as shown in FIG. 18A, there are 6 PUSCH repetitions in total, namely PUSCH repetition-1, PUSCH repetition-2, PUSCH repetition-3, PUSCH repetition-4, PUSCH repetition-5 and PUSCH repetition-6, where PUSCH repetition-1 and PUSCH repetition-2 are successive and belong to a first successive PUSCH repetition group; PUSCH repetition-2 and PUSCH repetition-3 are not successive, while PUSCH repetition-3, PUSCH repetition-4 and PUSCH repetition-5 are successive and belong to a second successive PUSCH repetition group; and PUSCH repetition-5 and PUSCH repetition-6 are not successive, and PUSCH repetition-6 belongs to a third successive PUSCH repetition group.

Then, for each successive PUSCH repetition group, the plurality of PUSCHs in the successive PUSCH repetition group are grouped into several PPCGs.

The principle for grouping is that the number of PUSCH repetitions in each of PPCGs is less than or equal to N4 (as previously mentioned, N4 may be obtained through receiving higher layer configuration signaling by the UE, or N4 may be obtained through receiving physical layer signaling (e.g., the physical layer signaling is the information in the DCI which schedules PUSCHs) by the UE). The number of PUSCH repetitions in each of PPCGs is uniform with other, the PPCGs being obtained by grouping within one successive PUSCH repetition group.

More specifically, it is assumed that the number of PUSCH repetitions in a certain successive PUSCH repetition group is L, and the number of PUSCH repetitions in each PPCG should be less than or equal to N4, where the rounding up of (L/N4) is equal to P. This successive PUSCH repetition group is grouped into P PPCGs, where the number of PUSCH repetitions contained in each of (P*N4-L) PPCGs is (N4-1), and the number of PUSCH repetitions contained in each of (P-(P*N4-L)) PPCGs is N4. For example, the number of PUSCH repetitions contained in each of the first PPCG (P-(P*N4-L)) PPCGs is N4, and the number of PUSCH repetitions contained in each of the last PPCG (P*N4-L) PPCGs is (N4-1).

For example, as shown in FIG. 18B, the number of PUSCH repetitions in a successive PUSCH repetition group is 11, and the number of PUSCH repetitions in each PPCG should be less than or equal to 3, where the rounding up of (11/3) is equal to 4. This successive PUSCH repetition group is grouped into 4 PPCGs, where the number of PUSCH repetitions contained in 1 (i.e., 4*3-11=1) PPCG is 2 (i.e., 3-1=2), and the number of PUSCH repetitions contained in each of 3 (i.e., 4-(4*3-11)) PPCGs is 3. For example, the number of PUSCH repetitions contained in each of the first 3 (i.e., P-(P*N-L)) PPCGs is 3, and the number of PUSCH repetitions contained in the last 1 (i.e., P*N-L) PPCG is 2 (i.e., N-1=2).

Employ this Manner V may make the numbers of PUSCH repetitions in each PPCG as much uniform with each other as possible, which can guarantee the performance of joint channel estimation for PUSCH repetitions in each PPCG. Again, this manner may also be used to determine DTBGs, except that the successive PUSCHs in a PPCG are replaced by the successive PUSCHs in a DTBG.,A plurality of PUSCH repetitions scheduled by DCI are grouped into a plurality of DTBGs using the above manner, so that for each DTBG, joint channel estimation is performed by employing DMRSs carried in the PUSCH repetitions included in the DTBG.

### Manner VI

The PPCG is grouped based on a preset maximum number of OFDM symbols in PUSCHs (or PUSCH repetitions, this Manner VI may be applied to individual PUSCHs or PUSCH repetitions, and hereinafter PUSCH repetitions will be taken as an example) belonging to one PPCG. A part of the plurality of PUSCH repetitions scheduled by one DCI is grouped into one PPCG, where the number of OFDM symbols in PUSCH repetitions belonging to one PPCG is less than or equal to a fifth preset number N5. The fifth preset number N5 may be obtained through receiving higher layer signaling or MAC signaling or physical layer signaling (e.g., the physical layer signaling is information in the DCI which schedules PUSCHs) by the UE, and the PUSCH repetitions belonging to one PPCG are successive in time domain.

Specifically, at first, a successive PUSCH repetition group is determined.

In some embodiments, a successive PUSCH repetition group means that the PUSCH repetitions in each successive PUSCH repetition group are mutually successive, and different successive PUSCH repetition groups are not mutually successive. For example, as shown in FIG. 18A, there are 6 PUSCH repetitions in total, namely PUSCH repetition-1, PUSCH repetition-2, PUSCH repetition-3, PUSCH repetition-4, PUSCH repetition-5 and PUSCH repetition-6, where PUSCH repetition-1 and PUSCH repetition-2 are successive and belong to a first successive PUSCH repetition group; PUSCH repetition-2 and PUSCH repetition-3 are not successive, while PUSCH repetition-3, PUSCH repetition-4 and PUSCH repetition-5 are successive and belong to a second successive PUSCH repetition group; and PUSCH repetition-5 and PUSCH repetition-6 are not successive, and PUSCH repetition-6 belongs to a third successive PUSCH repetition group.

Alternatively, in other embodiments, a successive PUSCH repetition group may be determined in such a way: one PUSCH repetition is partitioned into several segments of PUSCHs by unavailable symbols. For example, one PUSCH repetition is partitioned into three segments of PUSCH repetitions by unavailable symbols, and the OFDM symbols in each segment of PUSCH repetition are successive, so each segment of PUSCH repetition is equivalent to a successive PUSCH repetition group described above. In the following description a successive PUSCH repetition group is taken as an example for illustration. Of course, the expression “a successive PUSCH repetition group” may also be replaced with the expression “a segment of PUSCH repetition” for illustration.

Then, the PUSCH repetitions in each successive PUSCH repetition group are grouped into several PPCGs.

A principle for grouping is that the total number of OFDM symbols contained in PUSCH repetitions in each of PPCGs is less than or equal to the fifth preset number N5, and the number of OFDM symbols contained in PUSCH repetitions in each of PPCGs obtained by grouping within one successive PUSCH repetition group is uniform with each other. The “uniform” herein means “as much uniform as possible”, but not necessarily “absolutely uniform”.

More specifically, it is assumed that the total number of OFDM symbols in each successive PUSCH repetition group is L, and the number of OFDM symbols in each PPCG should be less than or equal to N5, where the rounding up of (L/N5) is equal to P. This successive PUSCH repetition group is grouped into P PPCGs, where the number of OFDM symbols in PUSCHs contained in each of (P*N5-L) PPCGs is (N5-1), and the number of OFDM symbols in PUSCHs contained in each of (P-(P*N5-L)) PPCGs is N5, for example, the number of OFDM symbols in PUSCHs contained in each of the first (P-(P*N5-L)) PPCGs is N5, and the number of OFDM symbols in PUSCHs contained in each of the last (P*N5-L) PPCGs is (N5-1).

For example, the total number of OFDM symbols in PUSCH repetitions in a successive PUSCH repetition group is 40, and the total number of OFDM symbols in PUSCH repetitions in each PPCG should be less than or equal to 14, where the rounding up of (40/14) is equal to 3. This successive PUSCH repetition group is grouped into 3 PPCGs, where the total number of OFDM symbols in PUSCH repetitions contained in each of 2 (i.e., 3*14-40=2) PPCGs is 13 (i.e., 14-1=13), and the number of OFDM symbols in PUSCH repetitions contained in 1 (i.e., 3-(3* 14-40) = 1) PPCG is 14, for example, the total number of OFDM symbols in PUSCH repetitions contained in the first 1 (i.e., P-(P*N4-L)) PPCG is 14, and the total number of OFDM symbols in PUSCH repetitions contained in each of the last 2 (i.e., P*N4-L) PPCGs is 13.

In this way, by ensuring that the number of OFDM symbols in PUSCHs (here, PUSCH repetitions are taken as an example) contained in each PPCG in a successive repetition group is as much uniform with each other as possible, the performance of joint channel estimation for PUSCHs in each PPCG can be guaranteed. Again, this method may also be used to determine DTBGs, except that the successive PUSCHs in a PPCG are replaced by the successive PUSCHs in a DTBG, that is, a plurality of PUSCH repetitions scheduled by DCI are grouped into a plurality of DTBGs using the above method, so that for each DTBG, joint channel estimation is performed by employing DMRSs carried in the PUSCH repetitions included in the DTBG.

In addition, another principle for grouping may be as follows: the total number of OFDM symbols contained in PUSCH repetitions in each PPCG should be less than or equal to the fifth preset number N5, and for each successive PUSCH repetition group, starting from the first symbol scheduled by DCI, the N5 successive OFDM symbols in sequential order are as one PPCG. If after M (M is less than N5) successive OFDM symbols in sequential order, there is an OFDM symbol which is not successive with the M-th OFDM symbol (e.g., there is an unavailable OFDM symbol after the M-th OFDM symbol), the M OFDM symbols are grouped into one PPCG. Then starting from the (M+1)-th OFDM symbol, the N5 successive OFDM symbols in sequential order are grouped into one PPCG, and so on until the last OFDM symbol scheduled by DCI is grouped.

Again, this method may also be used to determine DTBGs, except that the successive PUSCHs in a PPCG are replaced by the successive PUSCHs in a DTBG, that is, a plurality of PUSCH repetitions scheduled by DCI are grouped into a plurality of DTBGs using the above method, so that for each DTBG, joint channel estimation is performed by employing DMRSs carried in the PUSCH repetitions included in the DTBG.

In addition, in a case where the base station is configured to perform the joint channel estimation operation, after determining the PPCGs (or DTBGs) based on Manner VI, the UE may determine DMRS design time unit (DDTU) in each PPCG (or DTBG). Here, the DDTU is a time unit for determining DMRS, that is, each DDTU is made to contain a DMRS. The DMRS pattern in each DDTU is determined by the number of OFDM symbols contained in the DDTU, and the number of OFDM symbols contained in each DDTU is less than or equal to a maximum limit Q. The UE may obtain the Q by receiving higher layer signaling or physical layer signaling (e.g., the physical layer signaling is information in the DCI which schedules PUSCHs). Alternatively, the UE may determine the Q by receiving higher layer signaling or physical layer signaling and/or the number of OFDM symbols contained in PPCG.

For example, the UE obtains a first limit Q_1 and a second limit Q_2 for the number of OFDM symbols contained in each DDTU by receiving signaling (e.g., higher layer signaling or physical layer signaling), and determines one of the first limit Q_1 and the second limit Q_2 as the maximum value of the number of symbols in DDTU in the PPCG based on the number of symbols in the PPCG. More specifically, if the number of OFDM symbols contained in the PPCG is greater than a preset number L of symbols, the number of OFDM symbols contained in each DDTU is set to be less than or equal to the first limit value Q_1, and if the number of OFDM symbols contained in the PPCG is less than or equal to L, the number of OFDM symbols contained in each DDTU is set to be less than or equal to the second limit value Q_2.

Furthermore, it is assumed that the preset number L of symbols equals to 30, the first limit Q_1 and the second limit Q_2 are 10 and 5 respectively. When one PPCG includes 40 OFDM symbols, since the number of OFDM symbols contained in the PPCG is larger than the preset number L of symbols, the maximum value of the number of OFDM symbols contained in each DDTU is set to be the first limit 10. When the first limit 10 is set, there may be 4 DMRSs in the PPCG. Also, when one PPCG includes 10 OFDM symbols, if the number of OFDM symbols contained in each DDTU is still set to be equal to 10, then there is only one DMRS in the PPCG, so that joint channel estimation cannot be performed. Therefore, in this case, if the maximum value of the number of OFDM symbols contained in each DDTU is set to be the second limit 5, then there can still be two DMRSs in the PPCG, so that joint channel estimation may still be performed based on the use of the two DMRSs.

In this case, the UE has the DMRSs of DDTU determined based on the above method carried in PUSCH and then transmits the PUSCH to a communication device such as a base station, so that the communication device may perform joint channel estimation based on the DMRSs.

With this method, the requirement for the number of DMRSs in each PPCG may be guaranteed, thus guaranteeing the accuracy of the joint channel estimation using DMRSs, and thus guaranteeing the demodulation performance of PUSCH.

According to yet another embodiment of the present disclosure, the configured grant (CG) PUSCH (CG PUSCH) is configured by higher layer signaling or activated physical layer signaling, and the PPCG is determined for the CG PUSCH (which will be illustrated in detail in connection with Manner VII below).

### Manner VII

For a CG PUSCH configured by higher layer signaling or activated by MAC signaling or activated by physical layer signaling, PUSCHs in one PPCG may be a plurality of PUSCHs within one time unit (as previously mentioned, for example, one time unit may be L1 time slots, and L1 may be obtained through receiving signaling by the UE, for example, L1 may be obtained through receiving higher layer signaling configuration or physical layer signaling by the UE). For example, L1 is equal to 2, CG PUSCHs in the first time slot and CG PUSCHs in the second time slot are grouped into PPCG-1, and CG PUSCHs in the third time slot and CG PUSCHs in the fourth time slot are grouped into PPCG-2. This is similar to the case where PUSCHs are scheduled by DCI described with reference to FIG. 14.

Alternatively, considering whether the CG PUSCHs within one time unit are successive or not, each set of successive CG PUSCHs are grouped into one corresponding PPCG. For example, as shown in FIG. 19, CG PUSCH-1 and CG PUSCH-2 are located in time unit 1 and are successive, so CG PUSCH-1 and CG PUSCH-2 are grouped into PPCG-1. Also, CG PUSCH-3 and CG PUSCH-4 are located in time unit 2 but are not successive, so CG PUSCH-3 is grouped into PPCG-2, and CG PUSCH-4 is grouped into PPCG-3. This is similar to the case where PUSCHs are scheduled by DCI described with reference to FIG. 15.

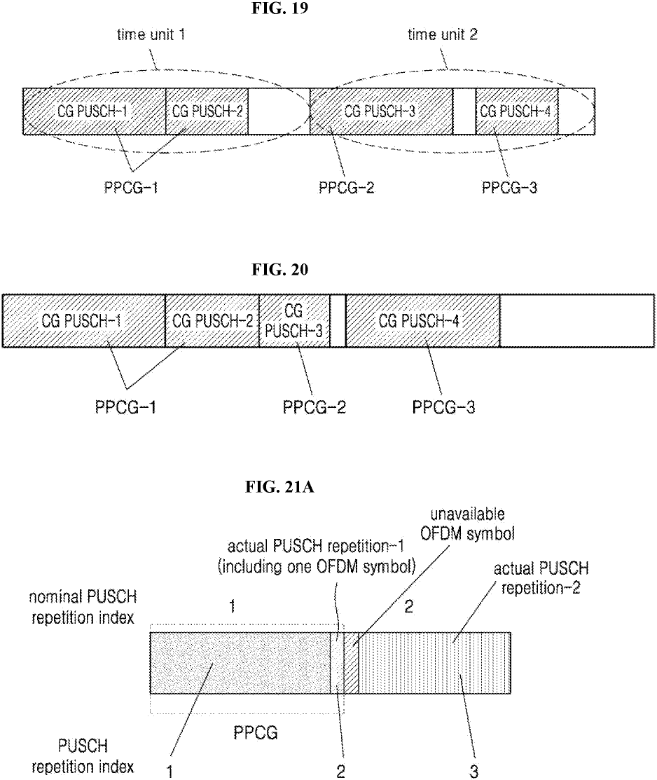

Alternatively, a sixth preset number, N6, of successive CG PUSCHs belong to one PPCG. For example, as shown in FIG. 20, N6 is equal to 2. Also, CG PUSCH-1, CG PUSCH-2 and CG PUSCH-3 are successive, so CG PUSCH-1 and CG PUSCH-2 are grouped into PPCG-1. Also, CG PUSCH-3 and CG PUSCH-4 are not successive, so CG PUSCH-3 are grouped into PPCG-2, and CG PUSCH-4 are grouped into PPCG-3. This is similar to the case where PUSCHs are scheduled by DCI described with reference to FIG. 16.

According to another embodiment of the present disclosure, as previously described, the joint channel estimation may be performed at a communication device such as a base station based on the DMRSs carried in the received plurality of PUSCH repetitions (including nominal PUSCH repetitions and/or actual PUSCH repetitions). While transmitting a certain PUSCH repetition (the number of OFDM symbols contained therein is less than or equal to a seventh preset number N7 (e.g., N7 is equal to 1)), the UE may decide whether the certain PUSCH repetition belongs to the same PPCG as at least one other PUSCH repetition, and determine whether to transmit the certain PUSCH repetition according to decision result.

The PUSCH repetition is transmitted if the PUSCH repetition and at least one other PUSCH repetition belong to the same PPCG, and the PUSCH repetition is not transmitted if the PUSCH repetition and any other PUSCH repetition do not belong to the same PPCG.

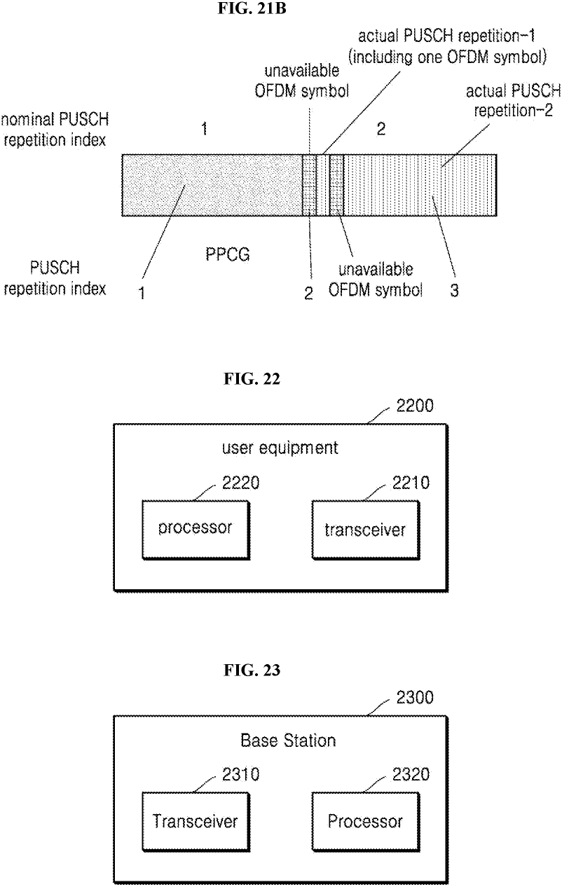

For example, as shown in FIG. 21A, the UE schedules two nominal PUSCH repetitions (each nominal PUSCH repetition contains more than one OFDM symbol). The OFDM symbols in the first nominal PUSCH repetition are successive. The second nominal PUSCH repetition is partitioned into two actual PUSCH repetitions, where the first actual PUSCH repetition contains one OFDM symbol and is successive with the first nominal PUSCH repetition. The first nominal PUSCH repetition and the first actual PUSCH repetition in the second nominal PUSCH repetition form one PPCG, and at this time, the first actual PUSCH repetition in the second nominal PUSCH repetition is transmitted.

As shown in FIG. 21B, the OFDM symbols in the first nominal PUSCH repetition are successive. The second nominal PUSCH repetition is partitioned into two actual PUSCH repetitions, where the first actual PUSCH repetition contains one OFDM symbol and is not successive with the first nominal PUSCH repetition. That is, the first actual PUSCH repetition in the second nominal PUSCH repetition does not form one PPCG with any other PUSCH repetition, and at this time, the first actual PUSCH repetition in the second nominal PUSCH repetition is not transmitted.

Employing this manner is advantageous in that if a PUSCH repetition with only one OFDM symbol belongs to the same PPCG as at least one other PUSCH repetition, the PUSCH repetition with only one OFDM symbol may be transmitted along with PUSCH repetitions belonging to the same PPCG for joint channel estimation, and thus improving the precision of the channel estimation. If the PUSCH repetition does not belong to the same PPCG as any other PUSCH repetition, the PUSCH repetition with only one OFDM symbol may not be transmitted, and thus saving power consumption for the UE and reducing interference. Similarly, this method may be used to determine DTBGs, except that the successive PUSCHs in a PPCG are replaced by the successive PUSCHs in a DTBG, that is, a plurality of PUSCH repetitions scheduled by DCI are grouped into a plurality of DTBGs using the above method, so that for each DTBG, joint channel estimation is performed by employing DMRSs carried in the PUSCH repetitions included in the DTBG.

Alternatively, in order to reduce the computation and signaling overhead, as long as the joint channel estimation operations (or the PUSCH power control group determination operations) are configured, when the number of OFDM symbols contained in a certain PUSCH is less than or equal to the seventh preset number, N7 (e.g., N7 is equal to 1), the certain PUSCH will be transmitted regardless of whether it belongs to the same PPCG as other PUSCHs.

Alternatively, when the UE receives higher layer signaling to determine whether to transmit a certain PUSCH in a case where the number of OFDM symbols contained in the certain PUSCH is less than or equal to a eighth preset number, N8 (e.g., N8 is equal to 1). That is, if it is configured by the higher layer signaling that the certain PUSCH should be transmitted in the above-mentioned case, the UE will transmit the certain PUSCH, and if it is configured by the higher layer signaling that the certain PUSCH should not be transmitted in the above-mentioned case, the UE will not transmit the certain PUSCH. In this way, it may be determined whether to transmit, for example, the PUSCH repetition with only one OFDM symbol, only by means of higher layer configuration, so that this PUSCH repetition may be used for joint channel estimation together with other PUSCH repetitions. Therefore, the precision of the channel estimation is improved, and the configuration is simple.

It should be noted that although in the above detailed description, a method of uplink channel transmission (including a method of PPCG-based power control and PPCG determination) is described for PUSCH transmission, this method may also be extended to PUCCH transmission.

According to another aspect of the present disclosure, a user equipment (UE) 2200 is also disclosed.

FIG. 22 shows an exemplary UE 2200 according to an embodiment of the present disclosure.

The UE 2200 includes a transceiver 2210 and a processor 2220.

The transceiver 2210 may transmit and receive uplink and/or downlink wireless signals in a wireless communication network in order to communicate with base stations or other terminals. The processor 2220 may be coupled to the transceiver 2210, and generate signals to be transmitted by the transceiver 2210, interpret signals received by the transceiver 2210, and/or control the operations of the transceiver 2210. The processor 2220 may perform various methods in all embodiments in the present disclosure.

FIG. 23 is a diagram illustrating a base station 2300 according to another embodiment of the present disclosure.

Referring to the FIG. 23, the base station 2300 may include a transceiver 2310 and a processor 2320. However, all of the illustrated components are not essential. The base station 2300 may be implemented by more or less components than those illustrated in FIG. 23. In addition, the transceiver 2310 and the processor 2320 may be implemented as a single chip according to another embodiment.

The aforementioned components will now be described in detail.

The transceiver 2310 may include a RF transmitter for up-converting and amplifying a transmitted signal, and a RF receiver for down-converting a frequency of a received signal. However, according to another embodiment, the transceiver 2310 may be implemented by more or less components than those illustrated in components.

The transceiver 2310 may be connected to the processor 2320 and transmit and/or receive a signal. The signal may include control information and data. In addition, the transceiver 2310 may receive the signal through a wireless channel and output the signal to the processor 2320. The transceiver 2310 may transmit a signal output from the processor 2320 through the wireless channel.

The processor 2320 may include one or more processors or other processing devices that control the proposed function, process, and/or method. Operation of the base station 2300 may be implemented by the processor 2320. The processor 2320 may perform various methods in all embodiments in the present disclosure. For example, the processor 2320 may transmit TPC, via the transmitter, to the UE performing power control according to one of the embodiments in the present disclosure.

Various embodiments of the present disclosure may be implemented as computer readable code embodied on a computer readable recording medium from a specific perspective. A computer-readable recording medium is any data storage device that may store data readable by a computer system. Examples of the computer-readable recording medium may include read-only memory (ROM), random access memory (RAM), compact disk read-only memory (CD-ROM), magnetic tape, floppy disk, optical data storage device, carrier wave (e.g., data transmission via the Internet), and the like. Computer readable recording media may be distributed by computer systems connected via a network, and thus computer readable codes may be stored and executed in a distributed manner. Furthermore, functional programs, codes, and segments of codes for implementing various embodiments of the present disclosure may be easily explained by those skilled in the art to which the exemplary embodiments of the present disclosure are applied.

It will be understood that exemplary embodiments of the present disclosure may be implemented in hardware, software, or a combination of hardware and software. Software may be stored as program instructions or computer readable codes executable on a processor on a non-transitory computer readable medium. Examples of non-transitory computer-readable recording media include magnetic storage media (e.g., ROM, floppy disk, hard disk, etc.) and optical recording media (e.g., CD-ROM, digital video disk (DVD), etc.). Non-transitory computer-readable recording media may also be distributed over computer systems coupled by networks, so that computer-readable codes may be stored and executed in a distributed manner. The medium may be read by a computer, stored in a memory, and executed by a processor. The various embodiments may be implemented by a computer or a portable terminal including a controller and a memory, and the memory may be an example of a non-transitory computer-readable recording medium suitable for storing program(s) having instructions to implement the exemplary embodiments of the present disclosure. The present disclosure may be realized by a program having codes for concretely implementing the apparatus and the method described in the claims, which is stored in a machine (or computer) readable storage medium. The program may be electronically carried on any medium, such as a communication signal conveyed via a wired or wireless connection, and the present disclosure suitably includes equivalents thereof.

Although the present disclosure has been described in connection with some embodiments, it is not limited to the specific forms set forth herein. On the contrary, the scope of the present disclosure is limited only by the appended claims. Furthermore, although one feature may appear to be described in connection with a particular embodiment, those skilled in the art will recognize that various features of the described embodiments may be combined according to the present disclosure. In the claims, the term of “comprise”, “contain” or “include” does not exclude the presence of other elements or steps.

In addition, although listed separately, a plurality of devices, elements or method steps may be implemented by, for example, a single unit or processor. In addition, although various features may be included in different claims, these features may be advantageously combined, and inclusion in different claims does not mean that the combination of features is not feasible and/or unfavorable. In addition, the inclusion of features in a type of claims does not imply a limitation on that type, but indicates that the features are equally applicable to other claim types (if appropriate).

1-15. (canceled)

16. A method performed by a user equipment (UE), the method comprising:
receiving indication information for demodulation reference signal (DMRS) bundling;
receiving information for scheduling physical uplink shared channel (PUSCH) transmissions;
identifying one or more time groups for the DMRS bundling based on the received indication information, wherein a time group for the DMRS bundling comprises a plurality of PUSCHs based on the scheduled PUSCH transmissions; and
transmitting the plurality of PUSCHs with a same transmission power in the time group for the DMRS bundling.

17. The method of claim 16, wherein identifying the one or more time groups for the DMRS bundling includes:
identifying a number of slots for the one or more time groups for the DRMS bundling; and
identifying PUSCHs scheduled by one downlink control information (DCI) as different time groups based on the number of slots,
wherein the number of slots is indicated via a higher layer signaling.

18. The method of claim 17, wherein the number of slots includes 2.

19. The method of claim 16, wherein identifying the one or more time groups for the DMRS bundling includes:
identifying the one or more time groups for the DRMS bundling based on a preset maximum time unit.

20. The method of claim 16, wherein identifying the one or more time groups for the DMRS bundling includes:
identifying successive PUSCHs among PUSCHs scheduled by one downlink control information (DCI) as one time group for the DMRS bundling.

21. The method of claim 16, wherein the scheduled PUSCH transmissions include PUSCH repetitions.

22. A user equipment, comprising:
a transceiver; and
a processor configured to:
control the transceiver to receive indication information for demodulation reference signal (DMRS) bundling;
control the transceiver to receive information for scheduling physical uplink shared channel (PUSCH) transmissions;
identify one or more time groups for the DMRS bundling based on the received indication information, wherein a time group for the DMRS bundling comprises a plurality of PUSCHs based on the scheduled PUSCH transmissions; and
control the transceiver to transmit the plurality of PUSCHs with a same transmission power in the time group for the DMRS bundling.

23. The user equipment of claim 22, wherein identifying the one or more time groups for the DMRS bundling includes:
identifying a number of slots for the one or more time groups for the DRMS bundling; and
identifying PUSCHs scheduled by one downlink control information (DCI) as different time groups based on the number of slots,
wherein the number of slots is indicated via a higher layer signaling.

24. The user equipment of claim 23, wherein the number of slots includes 2.

25. The user equipment of claim 22, wherein identifying the one or more time groups for the DMRS bundling includes:
identifying the one or more time groups for the DRMS bundling based on a preset maximum time unit.

26. The user equipment of claim 22, wherein identifying the one or more time groups for the DMRS bundling includes:
identifying successive PUSCHs among PUSCHs scheduled by one downlink control information (DCI) as one time group for the DMRS bundling.

27. The user equipment of claim 22, wherein the scheduled PUSCH transmissions include PUSCH repetitions.

28. A method performed by a base station, the method comprising:
transmitting indication information for demodulation reference signal (DMRS) bundling;
transmitting information for scheduling physical uplink shared channel (PUSCH) transmissions;
determining one or more time groups for the DMRS bundling, wherein a time group for the DMRS bundling comprises a plurality of PUSCHs based on the scheduled PUSCH transmissions; and
receiving the plurality of PUSCHs with a same transmission power in the time group for the DMRS bundling.
